(19) United States
(12) Patent Application Publication
(10) Pub. No.: US 2024/0100492 A1
(43) Pub. Date: Mar. 28, 2024

(54) NON AGGREGATING MICROFLUIDIC MIXER AND METHODS THEREFOR

(71) Applicants: Andre WILD, Vancouver (CA); PRECISION NANOSYSTEMS ULC, Vancouver, CA (US)

(72) Inventor: Andre WILD, Vancouver (CA)

(21) Appl. No.: 18/039,091

(22) PCT Filed: Nov. 18, 2021
(86) PCT No.: PCT/CA2021/051638

§ 371 Date: May 26, 2023

Related U.S. Application Data
(60) Provisional application No. 63/119,297, filed on Nov. 30, 2020.

(51) Int. Cl. B01F 33/30; B01F 25/432

(52) U.S. Cl. CPC B01F 33/30; B01F 25/4323

(57) ABSTRACT

Provided is a microfluidic mixing platform with a first and a second input port; a first output port; a flow path interconnecting the first input port, the second input port and the first output port; a first switch valve downstream of the first input port and upstream of the first output port, and a second switch valve downstream of the second input port and upstream of the first output port; and a first mixing feature downstream of the first and second switch valves and upstream of the first output port. The first switch valve is switchable between a first state and a second state, and in the second state the first switch valve prevents the first input port from being fluidly connected to the first mixing feature. The second switch valve operates in a similar way in the second state.

### FIELD

The subject-matter disclosed herein generally relates to continuous flow manufacturing of nanoparticles used in biomedical settings, wherein a mixing element is subject to blockage from aggregates within a microfluidic mixing platform.

### BACKGROUND

A microfluidic mixer (hereinafter “Mixer”) is a modern technology that uses materials science and hydraulics to achieve high-quality, consistent nanoparticles or emulsions for technical and biomedical applications. Such Mixers are sold by Precision NanoSystems Inc., Vancouver, Canada under the NanoAssemblr® brand.

Channel occlusion due to surface aggregation poses a problem in large-scale microfluidic (MF) mixing of lipid nanoparticles, as it impedes scale-up by preventing continuous flow manufacture. The problem manifests as a clouding of the mixing materials, and pressure increase within the Mixer over tolerated levels (which are about 50 to 200 PSI, for example). The overall effect is that the formulation process must be discontinued, the mixer cleared, and the process restarted multiple times before completion. The effects on the products of the manufacture may include less homogenous formulations, incomplete mixing, and unacceptable deviations in batch records. In addition, Mixer substructures such as pumps or mixing features may experience structural failures in the case of channel occlusion. It is particularly relevant for lipids and therapeutic agents which are large and complex, such as mRNA vaccines.

Different solvents and pH need to be used with care, because the final product must be safe for human administration, and, due to the delicate nature of nucleic acid therapeutics, the number of steps and environmental changes must be kept to a minimum. Thus, strong solvents which might reduce aggregation are not available.

When preparing nucleic acid based medicines larger than siRNA, and/or when using ionizable lipids and/or charged components, microchannel occlusion is a common problem which becomes apparent when the pressure within a microfluidic mixer rises to levels above the applied pressure, and/or fluctuates. When the pressure rises beyond certain pressure levels, mixing must be stopped to avoid structural failure of the integrity of the microfluidic cartridge, and the loss of expensive pharmaceutical-grade products.

It should be noted that the design and implementation of mixers on a microfluidic scale (<1000 μm dimension) differs considerably from those on the macrofluidic scale. In a micro system, the relatively short distances involved means that inertial forces are weak.

Secondly, many mechanical designs such as stirrers that can be easily manufactured on the macrofluidic scale are very difficult to implement on the microscale. These differences between the micro and macro scales create different problems requiring different solutions.

Furthermore, the cost of the reagents being mixed is generally very high, and so acceptable losses in a microfluidic scale are not acceptable for a microfluidic mixer.

Therefore, the solutions available for macroscale mixers are not practical for microscale mixers.

A solution for the problem of channel occlusion to enable continuous manufacture of nanoparticles in a clinically acceptable scale-up MF Mixer is therefore still needed.

### SUMMARY

According to embodiments of the invention, there is provided a microfluidic mixing platform including: at least a first input port and a second input port; at least a first output port; a flow path interconnecting the first input port, the second input port, and the first output port; at least a first switch valve downstream of the first input port and upstream of the first output port, and at least a second switch valve downstream of the second input port and upstream of the first output port; and at least a first mixing feature downstream of the first and second switch valves and upstream of the first output port; wherein the first switch valve is switchable between at least a first state and a second state, wherein in the first state the first switch valve allows the first input port to be fluidly connected via the flow path to the first mixing feature, and wherein in the second state the first switch valve prevents the first input port from being fluidly connected to the first mixing feature, and wherein the second switch valve is switchable between at least a first state and a second state, wherein in the first state the second switch valve allows the second input port to be fluidly connected via the flow path to the first mixing feature, and wherein in the second state the second switch valve prevents the second input port from being fluidly connected to the first mixing feature. In embodiments, the microfluidic mixing platform includes one or more controllers configured to control the states of the first and second switch valves such that: when the first switch valve is in the first state, the controller controls the second switch valve to be in the second state; and when the first switch valve is in the second state, the controller controls the second switch valve to be in the first state. In embodiments, the one or more controllers comprise a dedicated controller for each of the first and second switch valves. In further embodiments, the dedicated switch controllers are programmable separately or as a group.

In further embodiments of the invention, there is provided a microfluidic mixing platform including: a third switch valve downstream of the first mixing feature and upstream of the first output port, wherein the third switch valve is switchable between at least a first state and a second state, wherein in the first state the third switch valve allows the first mixing feature to be fluidly connected via the flow path to the first output port, and wherein in the second state the third switch valve prevents the first mixing feature from being fluidly connected to the first output port. In embodiments, the mixer further includes a waste output port downstream of the first mixing feature. In embodiments, there is a third switch valve downstream of the first mixing feature and upstream of the waste output port, wherein the third switch valve is switchable between at least a first state and a second state, wherein in the first state the third switch valve allows the first mixing feature to be fluidly connected via the flow path to the waste output port, and wherein in the second state the third switch valve prevents the first mixing feature from being fluidly connected to the waste output port.

In embodiments, the third input port interconnected to the first output port by the flow path. In embodiments the third input port is upstream of the first mixing feature. In still other embodiments, there is a third switch valve downstream of the third input port and upstream of the first output port, wherein the third switch valve is switchable between at least a first state and a second state, wherein in the first state the third switch valve allows the third input port to be fluidly connected via the flow path to the first mixing feature, and wherein in the second state the third switch valve prevents the third input port from being fluidly connected to the first mixing feature.

In embodiments, the microfluidic mixing platform further includes one or more controllers configured to control the states of the first and third switch valves such that: when the first switch valve is in the first state, the controller controls the third switch valve to be in the first state; and when the first switch valve is in the second state, the controller controls the third switch valve to be in the second state. In embodiments, the first and third input ports are for the introduction of materials, and the second input port is for the introduction of clearing buffer. In embodiments, the output port is for the exit of materials having been mixed in the first mixing feature. In embodiments, at least one of the first and second switch valves comprises a compression/diaphragm valve. In still other embodiments, at least one of the first and second switch valves comprises a valve selected from a group consisting of: a socket valve; a rocker valve; a flipper valve; a plunger valve; a capillary valve; and a ball valve.

In embodiments of the invention, at least one of the first and second switch valves is switchable between the first state and the second state in response to volumetric pressure. In embodiments, the first and second switch valves is switchable between the first state and the second state in response to pneumatic pressure. In embodiments, at least one of the first and second switch valves is switchable between the first state and the second state by a solenoid. In embodiments, there is a third switch valve downstream of the first input port and upstream of the output port; a fourth switch valve downstream of the second input port and upstream of the output port; and a second mixing feature downstream of the third and fourth switch valves and upstream of the output port, wherein the third switch valve is switchable between at least a first state and a second state, wherein in the first state the third switch valve allows the first input port to be fluidly connected via the flow path to the second mixing feature, and wherein in the second state the third switch valve prevents the first input port from being fluidly connected to the second mixing feature, and wherein the fourth switch valve is switchable between at least a first state and a second state, wherein in the first state the fourth switch valve allows the second input port to be fluidly connected via the flow path to the second mixing feature, and wherein in the second state the fourth switch valve prevents the second input port from being fluidly connected to the second mixing feature.

In embodiments, one or more controllers configured to control the states of the first, second, third, and fourth switch valves are provided, such that: when the first switch valve is in the first state, the controller controls the second and third switch valves to be in the second state, and controls the fourth switch valve to be in the first state; and when the first switch valve is in the second state, the controller controls the second and third switch valves to be in the first state, and controls the fourth switch valve to be in the second state.

In embodiments of the invention, the first mixing feature comprises one or both of a Dean's Vortex mixer and a herringbone mixer. In embodiments, there are one or more wireless communication components. In embodiments, the one or more wireless communication components comprise one or more radiofrequency identification components.

In embodiments of the invention there is provided a method of using a microfluidic mixing platform, the microfluidic mixing platform including: at least a first input port and a second input port; at least a first output port; a flow path interconnecting the first input port, the second input port, and the first output port; at least a first switch valve downstream of the first input port and upstream of the first output port, and at least a second switch valve downstream of the second input port and upstream of the first output port; and at least a first mixing feature downstream of the first and second switch valves and upstream of the first output port, wherein the method comprises: controlling the first switch valve to allow the first input port to be fluidly connected via the flow path to the first mixing feature, and controlling the second switch valve to prevent the second input port from being fluidly connected to the first mixing feature; thereafter, flowing a material from the first input port to the first mixing feature, via the flow path; thereafter, controlling the first switch valve to prevent the first input port from being fluidly connected to the first mixing feature, and controlling the second switch valve to allow the second input port to be being fluidly connected via the flow path to the first mixing feature; and thereafter, flowing a clearing buffer from the second input port to the first mixing feature, via the flow path.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates a two-dimensional outline of a pattern of input ports, output ports, compression valves, microchannels and mixing features characteristic of one embodiment of the disclosure;

FIG. 2 illustrates an alternate flow path in a two-dimensional outline of a pattern of input ports, output ports, pressure valves, microchannels and mixing features characteristic of one embodiment of the disclosure;

FIG. 3 is a line drawing of the microchannels and mixing features of a prototype flow switching microfluidic mixing platform showing one location for seals between sandwiched layers according to one embodiment of the disclosure;

FIG. 4 illustrates an example of a seating structure for reinforcing and connecting microfluidic mixing platform input and output nozzles to connect to tubing, according to one embodiment of the disclosure;

FIG. 5 is a prototype of a switching microfluidic mixing instrument according to one embodiment of the disclosure;

FIGS. 6-18 are different layouts of a microfluidic mixing platform according to alternative embodiments of the disclosure;

FIG. 19 is a graphical representation showing a degree of crosstalk and yield percentage as a function of delay time between switch cycles for POPC/Chol mixing, according to an embodiment of the disclosure;

FIG. 20 is a graphical representation of average particle size (shown by the top error bars and the vertical solid bars) and polydispersity index (PDI) (shown by the open ovals with error bars), for switched formulation of Tween80:cholesterol (3:9) ratio produced by a 2 mL/min 3:1 FRR, washed with a 120 mM Ammonium Sulfate buffer at different flow switching intervals of 15, 30, 45, 60, 75, and 120 seconds against zero seconds and a standard commercial mixer as controls, according to an embodiment of the disclosure;

FIG. 21 is a graphical representation of the average particle size (shown by the top error bars and the vertical solid bars) and polydispersity index (PDI, shown by the open ovals with error bars), for a switched formulation of POPC:cholesterol produced by flow rates of 18-22 mL/min 3:1 FRR with water as a clearing buffer at different flow switching intervals, according to an embodiment of the disclosure;

FIG. 22 is a plot of pressure during HPLC C12-200 formulation overlaid with a line graph of the pressure throughout the process over eight minutes time, illustrating the pressure effect of no switching on aqueous, lipid and clearing buffer streams in a microfluidic mixing platform according to an embodiment of the disclosure;

FIG. 23 is a plot of pressure during HPLC C12-200 formulation overlaid with a line graph of the pressure throughout the process over eight minutes time, illustrating the pressure effect of switching on aqueous, lipid and clearing buffer streams in a microfluidic mixing platform according to an embodiment of the disclosure;

FIG. 24 is an overlaid plot of internal microchannel pressure over a graphical illustration of LNP size (bars) and PDI (ovals) without switching, all over time, according to an embodiment of the disclosure; and

FIG. 25 is an overlaid plot of internal microchannel pressure over a graphical illustration of LNP size (bars) and PDI (ovals) with switching, all over time according to an embodiment of the disclosure.

Throughout the appended drawings, like features are identified by like reference numerals.

### DETAILED DESCRIPTION

The present disclosure seeks to provide an improved non aggregating microfluidic mixer and methods therefor. While various embodiments of the disclosure are described below, the disclosure is not limited to these embodiments, and variations of these embodiments may well fall within the scope of the disclosure which is to be limited only by the appended claims.

Microfluidic mixing platforms according to some embodiments of the disclosure include an inline clearing stream to minimize the potential presence of fouling by introducing a clearing stream to reduce any aggregation that may occur. This provides an alternative avenue to scale up for fouling formulations which cannot be scaled up by simply increasing the size of the mixer. Furthermore, the invention allows for the user to select different mixing protocols depending on the elements being mixed. Two or more mixing paths, timed switching, and alternating materials achieve the objective of the invention which is to provide a hygienic, reproducible, reliable manufacturing platform for pharmaceutical mixtures including lipid nanoparticles.

Incorporating sample flow switching on the cartridge 30 may reduce waste volume and increase automation, enable parallelization as a means of scale-up for fouling formulations, and normalize more complicated devices.

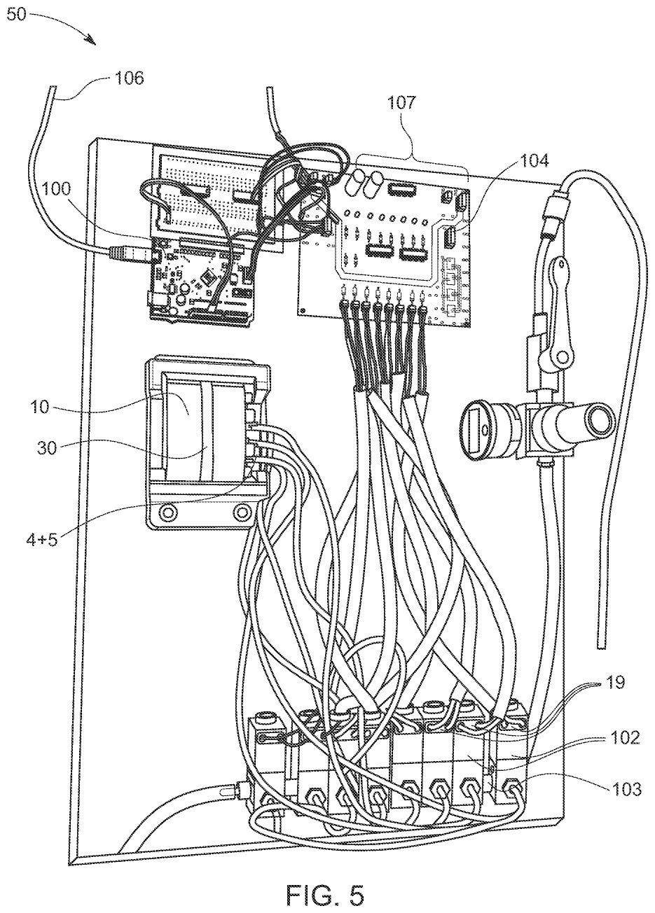

A microfluidic mixing platform, a prototype of which appears in FIG. 5, includes both instrument 50, or the mechanical pressure, fluid, and electrical setup, and cartridge 30, which is generally a consumable or cleanable cartridge including microchannels 12 and microfluidic mixing geometry 20.

The present disclosure describes microfluidic mixers that may eliminate the pressure drop caused by occluded back pressure inherent in microfluidic mixing scale-up manufacture, and that may mitigate the risk of aggregates contaminating the final product. Microfluidic mixers described herein may not only increase the reliability of the process, but may also enable the use of less expensive pumps which are not capable of overcoming occluded back pressure. This particular benefit lowers the cost of the system. Examples of such pumps are non-HPLC pumps such as Maglev™ pumps, peristaltic pumps, and Quatraflow™ pumps.

Embodiments of the disclosure will also reduce waste (and the resulting loss of expensive product), and increase the capacity of the system for automation and even portability. Thus, reliability and cost reduction are advantages of the instruments and processes described herein.

The microfluidic mixing platform comprises the instrument 50 and cartridge 30 and all that they encompass.

Instrument 50 comprises the microfluidic mixing mechanics and hardware (such as microcontrollers or the like) for controlling the mixing processors independent from the cartridge 30. According to some embodiments, instrument 50 comprises a mechanical base with pumps and connectors that powers the flow of fluids through the cartridge 30 to achieve mixing.

Instrument 50 may include a connection to a power source or battery 106, pump 17, circuit board with electronic controls 107, microcontroller/CPU 105. In embodiments, Instrument 50 includes a data reader or user input interface to take instructions from an RFID or data source on the cartridge 30, or from a user for directing mixing candidates or clearing buffer order and timing through the cartridge 30.

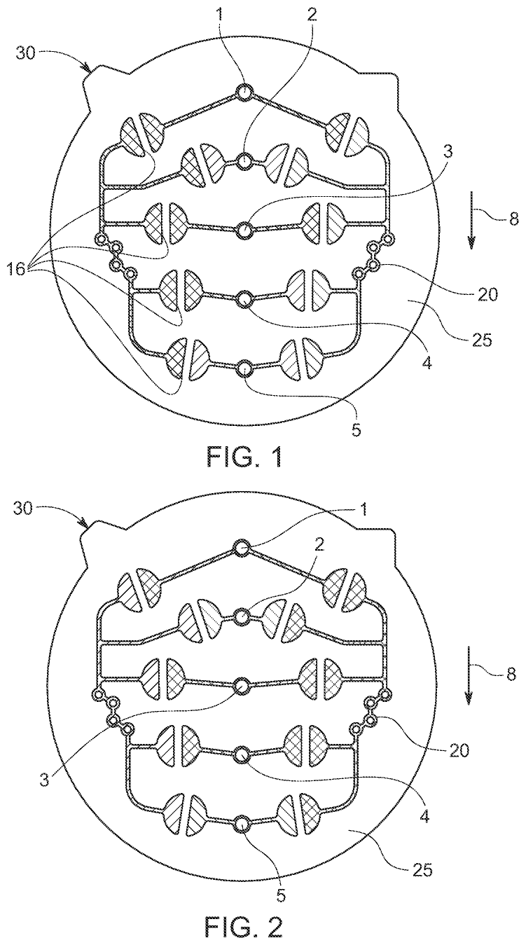

Referring to FIG. 1, cartridge 30 is an interchangeable aseptic or sterile part of the microfluidic mixing platform, and encompasses the microchannels, valves, mixing feature(s), input ports 1, 2, 3, and output ports 4, 5. The flow of different solutions for mixing are indicated by cross hatching or diagonal lines in FIG. 1 and, in an alternate flow pattern, FIG. 2. When the bulk 25 around the semicircular valves is compressed, the semicircular valves join each other in the middle, and fluid can flow between them.

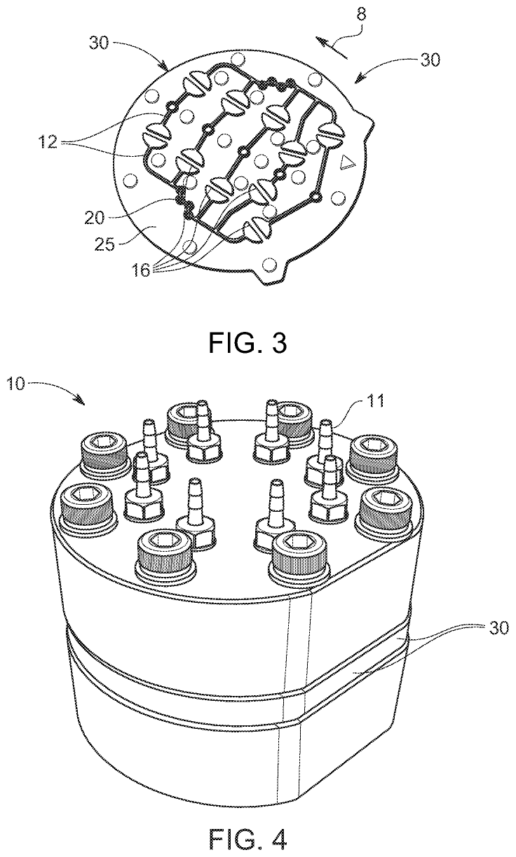

Thus in one embodiment, increased compression over different parts of the cartridge 30 lead to the joining of microchannels 12 and mixing of materials therethrough. This is a form of valve actuation. Decreased pressure over those semicircular areas closes the connection and no fluid may pass. The CPU 150 controls this process through electrical controls 107, not shown in these FIGS. 1 to 4. According to some embodiments, cartridge 30 comprises a bulk and secured organization of these encompassed elements. FIG. 3 is another illustration of a cartridge of the invention, showing where seals or screws would be located (unmarked circles). Thus in some embodiments, cartridge 30 includes seating protrusions or screw holes so that seating structure 10 (FIG. 4) may stably receive cartridge 30. In FIG. 4 we also see nozzles 11 through which mixing candidates and clearing buffer may enter the cartridge 30.

Cartridge 30 may further comprise microchannels and other microgeometries as described in any of the following patent publications: U.S. Pat. Nos. 9,758,795 and 9,943,846, by Cullis et al. (describing methods of using small volume mixing technology and novel formulations derived thereby); U.S. Pat. No. 10,159,652 by Ramsay et al. (describing more advanced methods of using small volume mixing technology and products to formulate different materials); U.S. Pat. No. 9,943,846 by Walsh, et al. (describing microfluidic mixers with different paths and wells to elements to be mixed); PCT Publication WO 2017/117647 by Wild, Leaver, and Taylor (describing microfluidic mixers with disposable sterile paths); U.S. Pat. No. 10,076,730 by Wild, and Leaver et al. (describing bifurcating toroidal microfluidic mixing geometries and their application to microfluidic mixing); PCT Publication No. WO 2018/006166 by Chang, Klaassen, Leaver et al. (describing a programmable automated micromixer and mixing chips therefor); U.S. Design Patent Nos. D771834, D771833, D772427, and D803416, by Wild and Leaver; and U.S. Design Patent Nos. D800335, D800336, and D812242 by Chang et al. (describing mixing cartridges having microchannels and mixing geometries for mixer instruments sold by Precision NanoSystems Inc.), the contents of all being herein incorporated by reference in their entireties.

In some embodiments, there are wireless communication components associated with the cartridge 30 and the instrument 50. For example, radiofrequency identification (RFID) tags may be embedded with a transmitter, a receiver, and a chip that processes and stores information. The tag may encode the unique serial number for a specific cartridge 30, and certain characteristics such as flow rates, volumes, and numbers of allowed uses can be programmed into the RFID tag.

Wireless data communication tags used in some embodiments are passive, in that they use a reader's radio wave energy to relay their stored data back to the reader. In other embodiments, a powered wireless communication tag is embedded with a small battery that powers the relay of information. The wireless communication tags are programmed either before or after embedding them in the microfluidic mixing cartridge 100 or instrument 50.

An example of how bilateral wireless communication can enhance the performance of microfluidic mixing platforms is found in PCT Publication WO 2018/006166 by Wild et al, the contents of which is herein incorporated by reference in its entirety.

Input ports 1, 2, and/or 3 comprise an entry into the mixing feature, usually via a length of microchannel 12. Input ports 1, 2, 3 may be a well or an opening for temporarily or permanently engaging with tubing or a conduit for reagents to be mixed.

Output port is a term meaning an exit point from the mixing volume of the cartridge 30. Output port 4 as indicated in the Figures is for the egress of finished mixed product such as LNP. Output port 5 is for the exit of clearing buffer or waste volume (waste volume being incompletely mixed formulation, or lead volumes of starting materials that precede formulation). Output ports exist in the cartridge 30 for the exit of two or more mixed materials or waste. Output port 4 is for the exit of mixed materials. In some embodiments, and with the use of additional valves, a single output port can be made to function for the egress of both mixed materials and waste.

Microchannels 12 are channels with small dimensions, typically less than 2 mm in diameter, more typically 1 mm diameter, and still more typically 900, 800, 700, 600, 500, 400, 300, 200, 100 or 50 μm in diameter.

Seating structure 10 is any physical brace or frame wherein the cartridge 30 is held in place and in association with fluidic feeds and egresses on instrument 50.

Switch actuator 19 of switch valve 16 refers to the electronic or physical trigger to a switch valve for opening or closing. Switch actuators 19 comprise the mechanical parts and electronic triggers that physically cause the switch valves 16 to open or close. Switch actuators 19 for controlling or regulating switch valves 16 are given a positioning signal by microcontroller 18 to move switch valves 16 to a predetermined position. In other embodiments, the switch actuators 19 are automated, and triggered by back pressure.

The switch actuators 19 are associated with the seating structure 10 in some embodiments. Switch actuators 19 may include gear actuators, electric motor actuators, pneumatic actuators, hydraulic actuators, and solenoid actuators in various embodiments. Switch actuators 19 may also include hydraulic pumps, gear pumps, rotary vane pumps, screw pumps, bent axis pumps, inline axial piston pumps and swash plate pumps, radial piston pumps, Maglev™ pumps, peristaltic pumps, and pneumatic pumps. A mixture of switch actuator types may be used.

Switch valve 16 comprise a controlled and reversible shut off of a fluidic path. Switch valve 16 can be closed, which means no fluid is allowed to pass through, or open, which means fluid is allowed to pass through. In some embodiments, switch valve 16 may be partly open. Switch valve 16 is controlled by switch controller 108. Generally, “valves” are mechanisms for stopping or controlling fluid flow in a channel, and include diaphragm valves, gate valves, globe valves, plug valves, ball valves, butterfly valves, check valves, pinch valves, flow valves, and control valves.

Pressure valving system electronics board 104 is a circuit board with a CPU 105 connecting switch controllers 108 to switch actuators 19, which connect to switch valves 16 Pressure valving systems electronic board 104 is under the control of with the electronic controls 107, and is generally housed in instrument 50. Electronic controls 107 include a user interface and CPU-interfacing circuits which allow a user to interact with the CPU 105, which in turn control the pumps and switch valves 16. CPU 105 may be a small computer on a single metal-oxide semiconductor-integrated circuit (IC) chip, and has one or more processor cores, memory, and programmable input/output peripherals. Power source 106 refers to the source of power to the instrument 50 and electronics. According to some embodiments, the power source may comprise either flowing electrical current or battery power. Equally, manual means such as a hand crank could achieve the desired goal if the lipid nanoparticles were being made off-grid or during a power shortage.

Mixing feature 20 is any form of structure in the cartridge 30 that creates mixing of the reagents into the formulation. In some embodiments, mixing feature 20 is a pattern of microfluidic channels whose turns, angles, and/or texture result in efficient fluidic mixing in a downstream portion of a fluidic path within the cartridge 30, wherein two or more reagents are combined under pressures adequate to compel reduction in diffusion distance. The mixing feature 20 may be, in some embodiments, a Dean Vortex mixer such as Precision NanoSystems' NxGen™ products, and in other embodiments, a staggered herringbone mixer or T-tube. In still other embodiments, the mixing feature 20 includes a combination of mixing structure types and layouts. In still other embodiments, the mixers may be posts or interrupters of the flow of reagents. In still other embodiments, mixing feature 20 may be a T-mixer, a Y-mixer, a branched mixer, a vortex mixer, or any combination thereof.

Mixing path is used herein to describe a semi-independent microfluidic mixing fluid path including the cartridge 30, microchannels 12, mixing feature(s) 20, some or all of switch valves 16, access to input ports 1, 2, 3, output ports 4, 5, reagent and product vessels, and associated tubing.

Occluded back pressure is used herein to describe the pressure exerted by an obstruction in the mixing feature (such an obstruction may be referred to as “fouling” throughout). To achieve maximal mixing rates and achieve an adequate duration of mixing, it is advantageous to avoid undue fluidic resistance prior to the mixing feature 20.

Pressure regulator 102 is a controller of the pressure in the mixing volume. In some embodiments, pressure regulator 102 works with a pressure sensor and is actuated by a high-pressure surge, or a low-pressure event. Pressure regulators 102 are pressure transducers or communicators, and may detect pressure variations and communicate such variations to the electronics board components, for example when such variations climb above or drop below a threshold. In some embodiments, pressure regulators 102 are connected to microchannels upstream of the mixing features 20, and are under control of pressure valving system electronics board 104. FIG. 5 shows a possible location for a pressure regulator.

Pressurized vessels 15 are reversibly sealed containers in valved fluidic communication with cartridge 30, and which variously contain, in embodiments, starting materials, clearing buffer.

“Programmable” means that a series of steps or processes required to automate a process, and controlled for example by CPU 105, can be established through written code in the memory of the instrument 50.

Volumetric pumps are powered positive displacement devices 17 which utilize positive displacement to move gas or liquid in a volume.

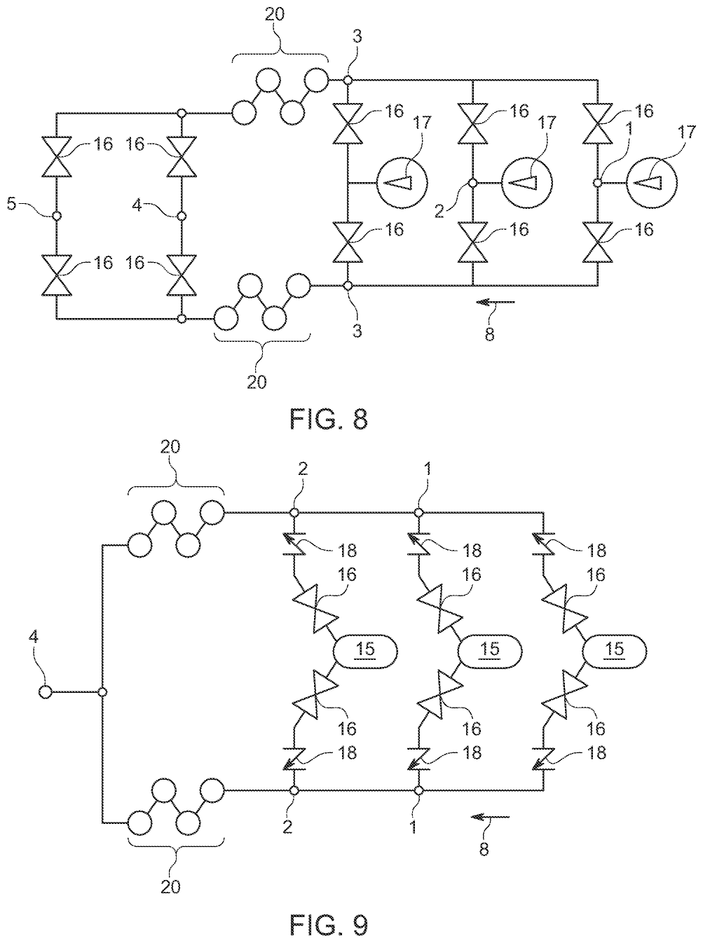

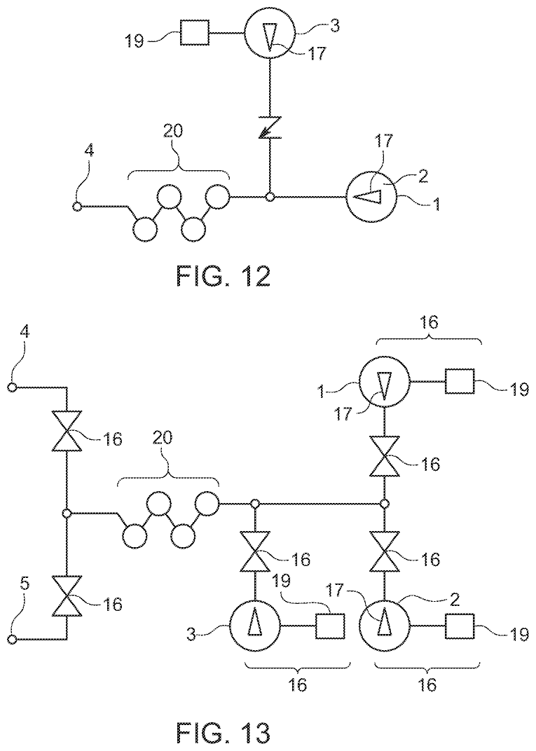

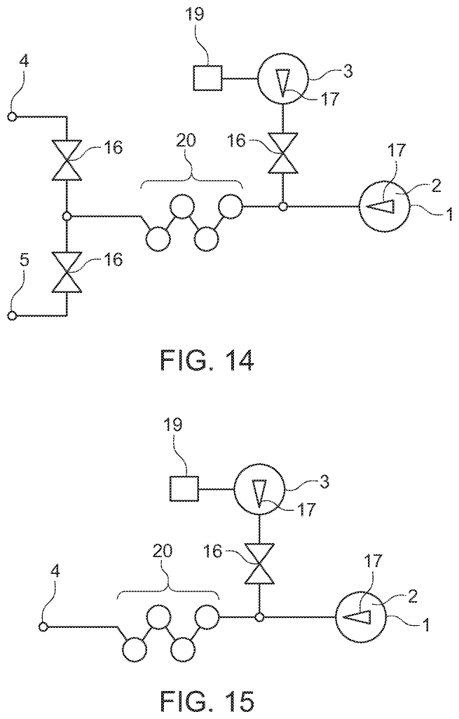

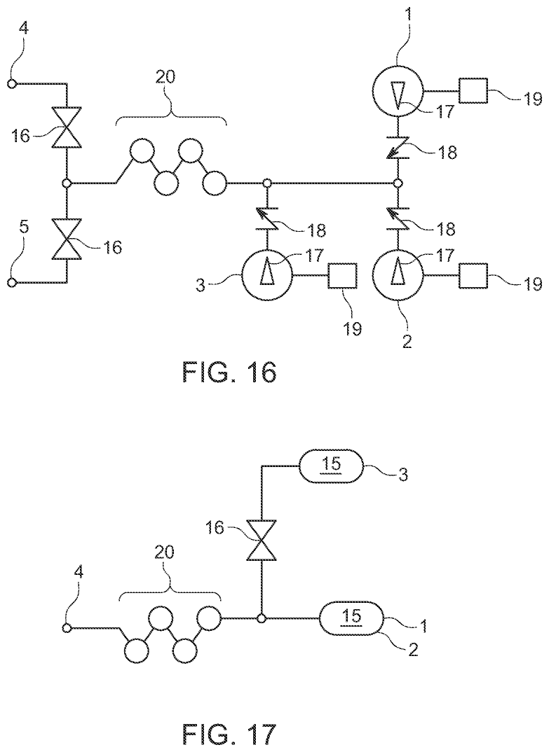

Pumps include hydraulic pumps, pneumatic pumps, Maglev™ pumps, vacuum pumps, and high-performance liquid chromatography (HPLC) pumps, for example. Some embodiments with integrated pumps 17 are shown in FIGS. 11 to 16. In some embodiments, pumps are external to the mixing platform. Pressure vessels 15 as shown in FIG. 8 for example act as both a fluid and pressure.

In other embodiments, switch valve 16 is a passive valve, and is pressure-responsive. Passive switch valves 16 open in response to pressure surges, then close again when the pressure is lessened in some embodiments. A valve is a reversible closure in a channel or vessel. Passive valves typically respond to pressure or force-driven deformation, and actuated valves are typically controlled mechanically, for example using mechanical switch valve actuators. Among the types of valves that may be used with embodiments of the disclosure are diaphragm valves, gate valves, globe valves, plug valves, flipper valves, plunger valves, rocker valves, ball valves, butterfly valves, check valves, pinch valves, flow valves, and control valves.

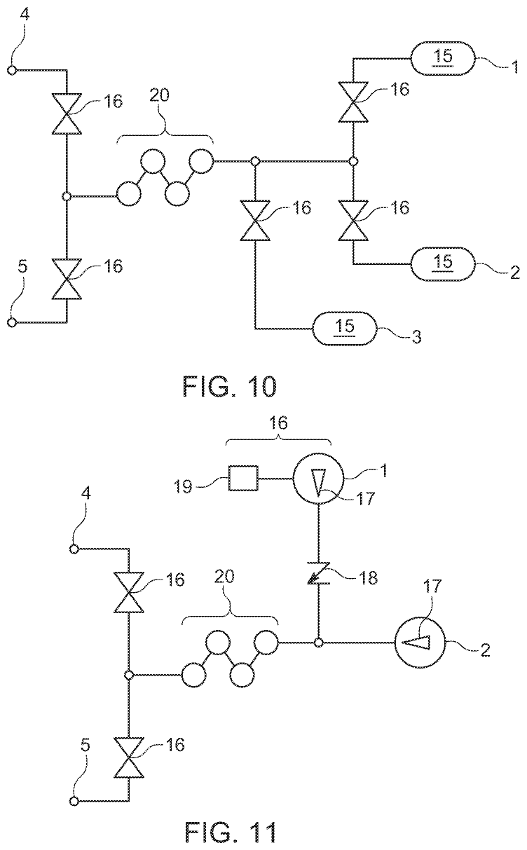

According to some embodiments, switch valves 16 are comprised in bulk 25, such as shown in FIG. 2, while according to other embodiments switch valves 16 are external to bulk 25. The switch actuators 19 are generally outside of the bulk 25 because they need to be mobile to achieve valve opening and closing, and because the cartridge 30 is single-use in some embodiments. FIG. 10 shows a layout wherein the switch valves 16 are outside of the bulk 25.

According to some embodiments, there is more than one input port. In some embodiments, input ports 1, 2, 3 are used for the starting materials for mixing, including therapeutic agents, lipid components, and clearing buffer.

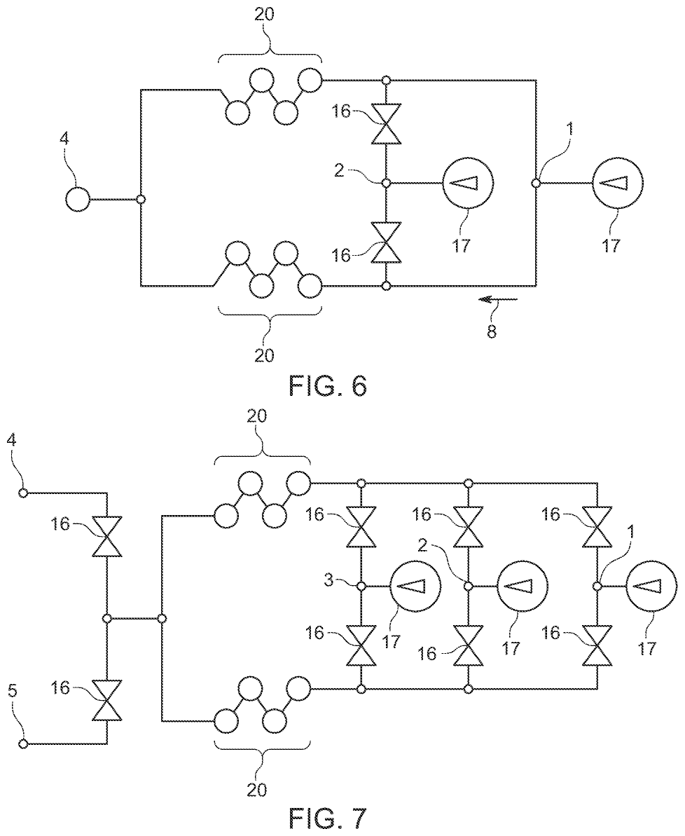

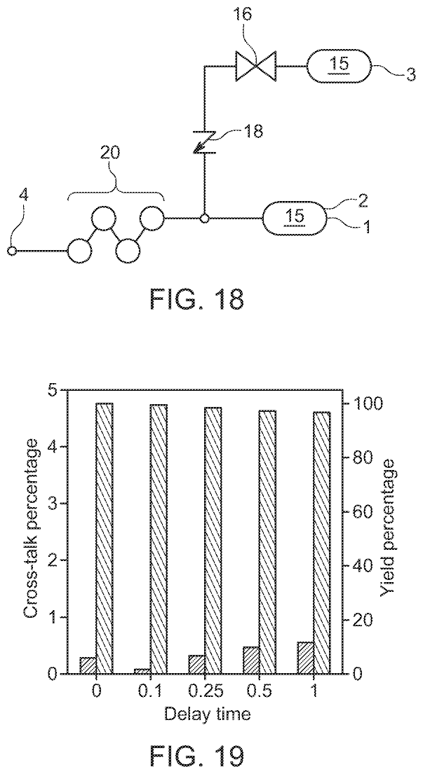

Fluid paths according to embodiments of the disclosure are illustrated in FIGS. 6 to 18, which are schematic embodiments of the invention. Flow direction arrow 8 shows the direction of fluid flow. Two of the input ports 1, 2 are generally for starting materials, and in some embodiments, a third input port 3 is connected to a vessel 15 of clearing buffer which can double as a dilution buffer in some embodiments. The outputs of the mixer(s) are connected to two output ports 4 and 5 via valves. One output port is connected to a collection reservoir in some embodiments, and the other is connected to a waste reservoir in other embodiments. This allows the mixing features 20 to be periodically cleared of any occlusion by turns, while maintaining continuous manufacture, enabling parallelization as a means to scale up fouling formulations.

The first state of the fluid path is the orientation of the microchannels and switch valves 16 wherein mixing of the active reagents can occur in a first mixing feature 20. An example of the first state appears in FIG. 1. A second state of the fluid path is the orientation of switch valves 16 that enables clearing buffer to pass through the mixing feature 20 of the first state, and in some embodiments enables mixing to occur within a second mixing feature 20. An illustration of a second state is shown in FIG. 2.

According to embodiments of the disclosure, a microfluidic mixing platform is provided including a cartridge 30 having a bulk 25, and at least two mixing features 20, each of which is connected to input ports 1 and 2 via switch valves 16. In some embodiments there is a third input 3 which is solely for clearing buffer. Cartridge 30 further includes output ports 4 and 5 downstream of the mixing feature 20 with, in some embodiments, switch valves 16 before and after the mixing feature 20 for one or both of output ports 4 and 5. In embodiments, the cartridge 30 is ensconced in the seating structure 10 of instrument 50. FIG. 4 is a perspective view of a seating structure 10 according to one embodiment of the disclosure. FIG. 5 shows seating structure 10 in the context of one embodiment of instrument 50.

In embodiments of the invention, cartridge bulk 25 may be comprised of any rigid or semi-rigid material. In embodiments of the invention, bulk is silica glass. In other embodiments, it is surgical steel or titanium. In embodiments of the invention, bulk is comprised of thermoplastic or thermoelastomer. In embodiments of the invention, bulk 25 comprises polycarbonate (PC), polypropylene (PP), cyclic olefin homopolymer (COP), or cyclic olefin copolymer (COC). In other embodiments, a combination of components makes up bulk 25.

In other embodiments, cartridge 30 is not solid but a collection independent mixing regions associated by shared connections from starting materials and to outputs. Thus the mixing regions are separate forms that together may be said to form the cartridge 30 in some embodiments.

To explain the role of microfluidic mixing features 20 depicted as a series of toroids in the Figures, recall that any system with different concentrations ultimately achieves a state of uniform concentration, or mixing. The time it takes to reach this point of complete mixing may depend on the diffusivity and distance over which diffusion must act in order to homogenize the concentration. In microfluidic mixing, diffusion distance is decreased and the area is increased as the pressure-driven fluid streams split, fold, and rejoin. The result is a massively accelerated mixing.

Mixing features 20 may be passive mixing features, according to some embodiments of the disclosure. Passive mixers may include injection mixers, lamination mixers, and chaotic advection mixers. Injection mixers rely on diffusion, with one stream with a small flow rate enters another, faster flowing, stream. Lamination mixers split flowing liquids into multiple streams that are then brought back together. Examples include serpentine plug mixers. Chaotic advection mixers, on the other hand, cause a dramatic acceleration of mixing. A cross flow mixer provides an example of a chaotic advection mixing feature. The staggered herringbone mixing feature disclosed in U.S. Pat. No. 9,943,846 by Cullis et al. is another example, as is NxGen™ microfluidic mixing features disclosed in U.S. Pat. No. 10,076,730 by Wild et al, both of which are hereby incorporated by reference in their entireties.

In the schematics for microfluidic mixer layouts according to some embodiments are shown in FIGS. 6-18. Switch valves 16 are the controlled valves, and the rectangles represent pressure vessels 15 which are downstream from input ports 1, 2, and sometimes input port 3. Pressure vessels 15 are present in FIGS. 9, 10, 17, and 18. Switch valves 16 are controlled, for example, by CPU 105. Passive valves 18 are associated with the use of volumetric pumps 17 as shown in FIGS. 11-16. In some embodiments, the passive valve 18 in association with a controlled volumetric pump or a controlled pressure vessel may act as a switch valve 16. According to some embodiments, the pressure vessels 15 may feed input ports 1, 2, 3.

Typically, “starting materials” are intended to describe fluids containing materials to be mixed, for example: a hydrophobic mixture including neutral lipids, charged or ionizable lipids, polymeric surfactants such as PEG-DMG or Myrj52, and cholesterol; an organic mixture including nucleic acid, ETOH, and aqueous buffer. In some cases, a polymeric agent such as polylactic glycolic acid (PLGA) needs to be in an organic phase. Polymeric agents such as polyvinyl alcohol would be in an aqueous phase.

“Formulation” is the resultant product of mixing reagents. A formulation may also be referred to as a composition or product.

“Clearing buffer” may comprise a ionic fluid used to flush the microchannels and mixing features 20 to clear occlusion at timed intervals. In some embodiments, clearing buffer comprises NaCl, Mg₂Cl, or NaAcO₄, for example. In preferred embodiments, it is a buffer that is nontoxic.

The instrument 50 encompasses or interacts with the power source which may be in the form of a battery or a connection to AC current, pumping mechanisms, electronics, memory storing computer program code, a user interface, and controls required for precise microfluidic mixing. The cartridge 30 generally comprises a body of rigid material (“bulk” herein), and in some embodiments may comprise a rigid thermoplastic material. Cartridge 30 further comprises microchannels and other microgeometries as described throughout the disclosure.

In some embodiments, the microfluidic mixing platform is used to prepare lipid particles and therapeutic formulations. The mixing platform includes a first and second channel to accommodate the flow of reagents fed into the microfluidic mixer, and formulation such as lipid nucleic acid nanoparticles are collected from an output port, or in other embodiments, emerge into a closed, sterile environment for patient use.

The first stream includes a therapeutic agent in a first solvent. Suitable first solvents include solvents in which the therapeutic agent is soluble and that are miscible with the second solvent. Suitable first solvents include aqueous buffers in the case of, for example, nucleic acids. Representative first solvents include phosphate, citrate and acetate buffers.

The second stream includes lipid or polymer mix materials in a second solvent. Suitable second solvents include solvents in which the lipids are soluble and that are miscible with the first solvent, and include 1,4-dioxane, tetrahydrofuran, acetone, acetonitrile, dimethyl sulfoxide, dimethylformamide, acids, and alcohols. Representative second solvents also include aqueous ethanol 90%, or anhydrous ethanol.

“Downstream” and “upstream” in this application are intended to denote direction of fluid flow in a microchannel from an input port or input location toward an exit or drawing-off point. Arrows marked with 8 in FIGS. 6 to 18 denote flow direction.

“Fluid flow rate” as herein defined is determined by a combination of the pressure from pumps or pressure transducers of instrument 50, and the geometry of the microchannels, valves, and mixing features, and the viscosity and composition of the reagents, formulation, and clearing buffer.

“Channel occlusion” or “fouling” are intended to mean aggregation, variations in viscosity, plugs, clogs, etc. of the microchannels particularly within a mixing feature 20. Channel occlusion is quantitatively measured using by pressure sensors to monitor pressure increases in the mixer because it can be difficult to visualize channel occlusion. Channel occlusion may be caused by interaction of the mixing fluids with the channel walls. A possible outcome of channel occlusion is a seal failure, and lost product.

“Microchannel” 12 is used herein to describe a linear or curvilinear passage of typically about 80 to 1000 microns in width, or 600 to 900 microns in width. In some embodiments, the microchannels are 80 microns to 500 microns wide, and 80 microns to 500 microns in height. In some embodiments, the microchannels are 500 to 1000 microns in width and height. For ease of manufacture, microchannels are generally rectangular in cross-section. In other embodiments, they may be square, round, circular, oval, ellipsoid, or semicircular. Microchannels, in some embodiments, may be 500 by 500 microns, 600 by 600 microns, 700 by 700 microns, 800 by 800 microns, 900 by 900 microns, or 1000 by 1000 microns in size (width by height), or more than 1000 microns, or any combination of those dimensions.

A seating structure 10 for the cartridge 30 is present in some embodiments, and includes, in some embodiments, a clamping or compression feature to variously seal the cartridge 30 output ports and input ports with reservoirs of solutions to be mixed, clearing buffer, resulting mixed formulation, and waste. The seating structure 10 also incorporates switch actuators in some embodiments.

Tubing or resilient detachable fluid path components leading to reservoirs of starting reagents or clearing buffer as described above are connected to the input and output ports.

In some embodiments, the microfluidic mixing instrument can be used in any situation in which pressure is applied to push fluid through the fluid path to mix the contents. Syringes are used in some embodiments. Powered, mechanized pumps are used more often.

In this disclosure, the word “comprising” is used in a non-limiting sense to mean that items following the word are included, but items not specifically mentioned are not excluded. It will be understood that in embodiments which comprise or may comprise a specified feature or variable or parameter, alternative embodiments may consist, or consist essentially of such features, variables, or parameters. A reference to an element by the indefinite article “a” does not exclude the possibility that more than one of the elements is present, unless the context clearly requires that there be one and only one of the elements.

In this disclosure, the recitation of numerical ranges by endpoints includes all numbers subsumed within that range including all whole numbers, all integers and all fractional intermediates. In this disclosure, the singular forms “an”, and “the” include plural elements unless the context clearly dictates otherwise. Thus, for example, reference to a composition containing “a compound” includes a mixture of two or more compounds.

In this disclosure, the term “or” is generally employed in its sense including “and/or” unless the context clearly dictates otherwise.

EE %=Encapsulation efficiency

PDI=Polydispersity Index or the dispersity of nanoparticle sizes

“Lipid nanoparticle” refers to a small particle comprising uncharged and charged lipids, aqueous components, and surfactant. Nanoparticles can be carriers for drugs including nucleic acid therapeutics such as siRNA, plasmids, and mRNA. Nanoparticles can be used in ex vivo, or in vivo. The term “nanoparticle” means a particle of between 1 and 500 nm in diameter, and as used herein can comprise an admixture of two or more components, examples being lipids, polymers, surfactants, nucleic acids, sterols, peptides, and small molecules. Examples of nanoparticle technology as well as methods of making them are disclosed in U.S. Pat. No. 9,758,795 by Cullis et al., and U.S. Pat. No. 9,943,846 by Wild et al, the contents of both of which are herein incorporated by reference in their entireties.

Microfluidic mixing is a standard microfluidic mixing platform cartridge type wherein two elements enter, combine, are pressurized through a mixing feature, and exit out of one outlet.

According to the present disclosure, mixing occurs in one mixing geometry along a first mixing path, and is then “switched” to a parallel mixing geometry on a separate second mixing path, while the first mixing path is cleared with a buffer stream, and then the mixing solutions switch back to the original mixing path and switch back at a steady period. The alternating flows of materials are implemented by pumps, actuated valves, and computer-assisted controls at the “switches”.

The Malvern Zetasizer® DLS is a nanoparticle sizing instrument which gives quantitative readouts on particle size and the range of sizes in a sample. A consistent size, or a low “polydispersity index”, is desired in most lipid nanoparticle preparations.

### Example 1

Prototype Assembly for Testing

A cartridge (FIG. 3) was custom manufactured to provided specifications in Topas 5013L-10 COC material at Protolabs, Inc. (Main Plains, MN) and Fineline Manufacture, Nepean, ON. Microfluidic tubing was purchased from VWR. The aluminum/stainless seating structure (FIG. 4) was custom manufactured at Protolabs Firstcut to a number of specifications. Other components of the prototype included HPLC fittings, tubes, and supplies (Waters UK, Elstree, Herts, UK), a pressure regulator 102 (Parker Watts, Cleveland Ohio), a nitrogen gas cylinder for gas pressure (Praxair, Vancouver, Canada), pumps (Cole-Parmer Lab Supplies, Vernon Hills, IL, USA), syringes (VWR), solenoid valves 103 (Sizto Tech Corp, Palo Alto, USA), a pressure valving system electronics board (Adafruit, New York, USA adapted with parts from Digikey, Minnesota, USA) 104, and a 3D-printed microfluidic mixing platform cartridge 30 (manufactured in-house). The prototype components were secured to a transportable surface using double-sided tape to form an overall structure 50. Output ports 4 and 5 of the microfluidic mixing platform cartridge 30 were left facing out to be easily accessible. As shown in FIG. 5, the prototype connects the cartridge 30 with pressure sources 103 and electronic controls 107, as well as a power source 106.

Input and output tubing is not visible in FIG. 5 because it would be one the other side of the assembly. The cartridge 30 with valves numbered according to their placement in the array can also be depicted as in the following schematic.

2 Aqueous in 3
|----[><]-------0-------[><]----|
| |
| 0 Cleaning in 1 |
|----[><]-------0-------[><]----|
| |
| 2 Ethanol in 3 |
|----[><]-------0-------[><]----|
| |
\O\ \O\
/O/ /O/
\O\ \O\
/O/ /O/
| 4 Out 5 |
|----[><]-------0-------[><]----|
| |
| 6 Waste 7 |
|----[><]-------0-------[><]----|

Switch valve combinations: each fluid mixing path of the cartridge is, when the switch valve 16 is closed, independent of the other, with no bleed-through or cross talk. Aqueous and ethanol streams travel to the output port (i.e. 2 goes to 4, 0 goes to 6, 3 goes to 5, and 1 goes to 7) and the opening and closing of switch valves should alternate. In one embodiment, when 2 is open, 0 and 3 are closed and 1 should be open for the input ports.

For the output port sides, 4 and 7 should be open while 5 and 6 are closed. After the switch valve, where delays are involved, the remnants of the formulation in the mixer to be cleared travel out to the output port before the formulation begins again. If 2 is open at first, then, during the delay, 2 and 0 are both open, 4 is closed and 6 is open to allow all the material in the mixer to go to waste. When programming the microcontroller 100, the valve order was set to [0,1,2,3,4,5,6,7] for the mixing feature embodiments shown in FIG. 1 and FIG. 2.

The valve tubing was connected to the cartridge 30 at the input and output ports. Diaphragm valves acted as switch valves 16 and were matched to their specified input and output ports 1 through 5. The valves were connected to a valve controller 100 incorporated into electronics board 104 and connected to CPU 105, which in turn was connected to a nitrogen air cylinder. The prototypical layout is shown in FIG. 5. To exert pressure, the nitrogen cylinder was opened and gas allowed to flow to the pressure regulator 102. The valve of the pressure regulator closest to the pumps was opened to allow gas flow to the solenoid valves 103, and the pressure was adjusted to ensure a pressure reading of 90 psi. The pumps were set to a flow rate starting at 9 mL/min unless otherwise specified.

Fluorescein Testing Data and Results on Flow Switching

To measure crosstalk between left and right mixer sides, 0.05 mg/ml fluorescein dye in water was delivered through the clearing inlet with 1×PBS in the formulation side (aqueous and lipid inlets). To measure yield, Fluorescein dye (Poly(lactide co-glycolide)-Fluorescein) (PolySciTech, West Lafayette, IN, USA) was delivered through the clearing line. Experiments were conducted with switching delays of 0-1 second. Several repetitions of this experiment were done over different days and by different technicians. For all experiments, solenoid valve pressure was maintained at 85-90 psi and three sensors recorded fluid pressure data at the input of each fluid line. Microchannels of 400 μm were used.

The fluorescein solutions were prepared at different concentrations in 1×PBS to establish a standard curve. Samples were collected in foil-covered tubes. A variety of fluorescein and 1×PBS patterns were used to test the pressure switch valves. The sample signal intensities were read on a Biotek™ microplate reader (Biotek, Winooski, VT, USA), and then plotted against a normal standard curve of fluorescein concentrations. The experiment was run three times.

Pumps were primed and the 5% fluorescein dye mixture was flowed through the input port(s) labelled 1, 2 (as shown in FIG. 6, for example). The dye was observed exiting out of the tubing at ports 4 and 5 (see FIG. 6).

Fluorescein was injected into the clearing input port at 20 mL/min, then a buffer solution was injected at the same flow rate. Flow switching states (right or left mixing sides) were switched every 15 s with both sides of the device going to a waste reservoir for 0-1 s.

Output was collected and fluorescence intensity was measured using a plate reader.

“Crosstalk” is a measure of leakage of reagents from one mixing path to the next, and is a measure of system reliability. Crosstalk was calculated as the concentration of fluorescein dye in the collected sample divided by total inlet concentration of fluorescein. Yield is calculated as one minus the concentration of fluorescein collected in waste divided by total concentration.

Crosstalk was measured at <1% for all delays, with yield of >90%. Results are shown in FIG. 19. The concentration of fluorescein in the collected fluid divided by the initial concentration gives the amount of crosstalk. In all cases crosstalk was below 1%. A delay time of 0.1 s was optimal in reducing crosstalk.

### Example 2

Liposome Preparation with and without Switch Mixing

The process was run on an Ignite™ NanoAssemblr® microfluidic mixer with a ReoTemp® 0-600 PSI Sensor and NxGen™ 160 μm microfluidic cartridge. This PSI sensor was connected to an arduino that used resistors to create upper and lower bounds of the output amps (4-20 mA) and convert that current to a readable voltage. Numerical changes were made in the microcontroller code to account for the pressure limits. Water/Ethanol and Sodium Acetate/Ethanol controls were used. Cleaning buffers were used.

POPC (1-palmitoyl-2-oleoyl-sn-glycero-3-phosphocholine)/cholesterol liposome is a non-aggregating lipid mixture. Components were obtained from Avanti Polar Lipids, Alabaster, Alabama, USA.

Size and polydispersity index (PDI) of particles made with the cartridge 30, seating structure 10, and instrument 50 were measured by Malvern Zetasizer™ Dynamic Light Scatter observed through microplate wells. A 100 mL lipid stock of POPC-Chol was used. The flow rate ratio (FRR) was at 3:1, and the total flow rate (TFR) was 18 mL/min.

In one experiment, the switch controllers were programmed to actuate flow switching at different times, and in particular 15, 30, 45, 60, 75, and 120 s at a flow rate of 12 mL/min.

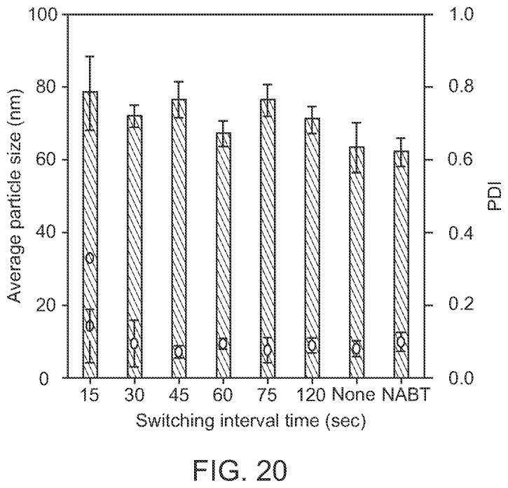

The size of the resulting nanoparticles is shown in FIG. 20, and the polydispersity index or range of nanoparticle size is shown as ovals. “NABT” was a legacy NanoAssemblr® microfluidic mixer with no switching capabilities, used as a benchmark. Collection of samples was taken from the sampling port, and the samples were sized using the Zetasizer® DLS reader.

In another experiment, the switch controllers were programmed to actuate flow switching with different delay times, starting with 0 s, then 0.1 s, then 0.25 s, and finally 0.5 s. Collection time was at the 60 s time point. Three pumps were used to propel the materials for mixing and clearing buffer for the formulation set up: aqueous, clearing stream, and lipid mix stream.

Samples were collected from the sampling port, and the samples were sized using the Malvern Zetasizer® DLS reader, an instrument which gives quantitative readouts on particle size and the range of sizes in a sample. A consistent size, or a low “polydispersity index”, is desired in most lipid nanoparticle preparations.

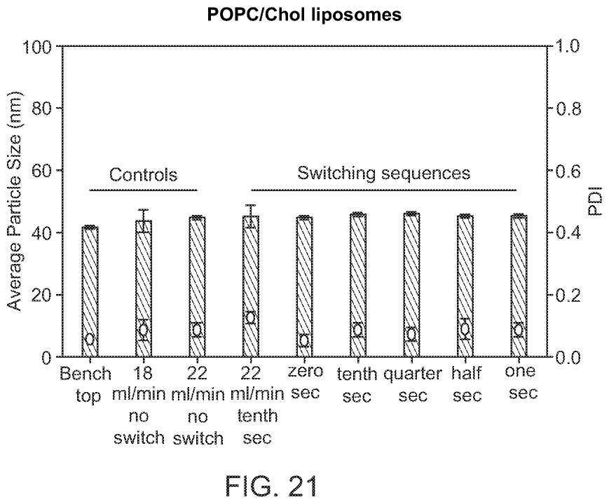

Sizing, PDI and particle size results are illustrated in FIG. 21. PDI is represented by ovals within the particle size bar.

In a third experiment. liposomes were formulated using a DSPC:Chol:DSPE-PEG 2000 lipid mix at a concentration of 15 mg/ml, with a flow rate ratio of 3:1 with 1×PBS. Control liposomes were formulated at 12 ml/min on the Ignite benchtop. All other formulations were conducted with the switcher at 6-22 ml/min flow rates with no switching, then at 18 ml/min with 0-1 s delayed switching. Particles were sized using a Zetasizer™ to assess particle quality.

For the DSPC:Chol:DSPE-PEG 2000 liposome, particle size and PDI decreased with increasing flow rate. Particles ranged from >200 nm and 1.3 at 8 ml/min to 50 nm and <0.2 at 22 ml/min. Particles formulated on the switcher at 18 ml/min had an average size of 60 nm, regardless of switching delay time, although the zero second delay sample showed the largest variation in size between samples. Standard non-switcher Ignite formulated liposomes had an average size of 40-50 nm and a PDI of <0.2, indicating similar particle quality for control and switching samples at 18 ml/min.

Results of the DSPC liposome experiment are illustrated in FIG. 20.

### DISCUSSION

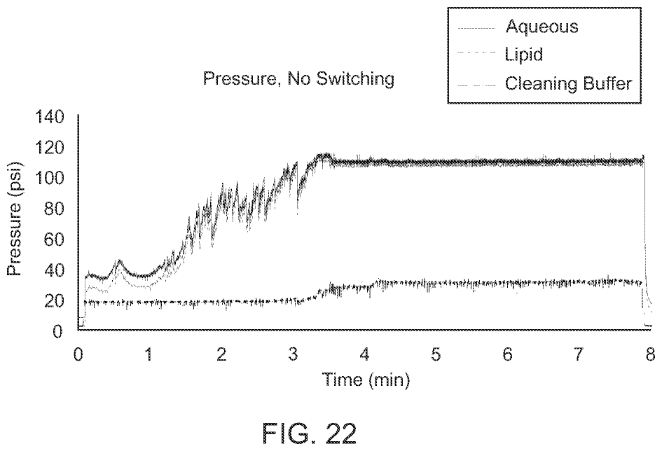

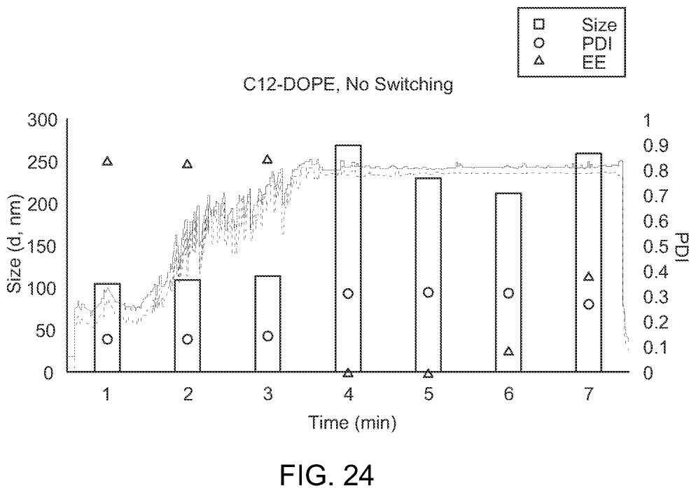

In non switching testing, the flat plateau for the first several seconds represents the solvents being flushed out before the formulation reaches the mixer. The pumps had been primed with the buffer solvents and therefore did not show fouling until the starting materials started to interact in the mixer. As can be seen in FIGS. 22 and 24, a sharp increase to 60 PSI occurs as soon as the reagents start mixing. Beyond 60 PSI, there is a steady increase of pressure over time. Sharp increases in pressure occur when fouling occludes the channels. When these restrictions build up, the velocity of the fluid moving through the narrowed mixing regions increases dramatically as the velocity is related to the radius of the channels. The increased velocity and respective increase in shear rate will cause some ‘self-defouling’ which causes chunks of the fouled mixing material to remove itself from the wall. This can be seen in the pressure profile by the sudden decreases in pressure. However, the overall pressure trend continues to go up over the entire formulation.

Not shown, but in some tests, a sharp decrease in pressure at the end of the formulation was due to the system starting to leak.

### Example 3

This experiment elucidates how fouling affects the sizing and formulation of particles and whether the increase in fouling continues linearly, or is a function of the amount of fouling.

Nanoparticle Size With and Without Switching

The most bulky (and challenging) therapeutic worked with were plasmids (pDNA). In terms of lipid components, C12-200 (1,1′-((2-(4-(2-((2-(bis(2-hydroxydodecyl)amino)ethyl)(2-hydroxydodecyl)amino)ethyl)piperazin-1-yl)ethyl)azanediyl)bis(dodecan-2-ol) is available from Organix Inc. (Woburn, MA) and was difficult to formulate due to aggregation during mixing.

Lipid Stock (C12-200) was prepared either the day of use or from frozen stock. The aqueous solution (pDNA stock) was prepared in the amount needed on the day of use for the tests contemplated, and so that the amino to phosphate ratio (N:P) would be 6.00. The ratios were C12-200 (50%)/DSPC (10%)/Cholesterol (38.5%)/PEG-DMG 2000 (1.5%) for the lipid components.

A. Lipid Nanoparticles were formulated using a C12-200:DOPE 25 mM lipid mix in ethanol, and either 3.2 or 6.1 kb plasmid DNA aqueous mix I sodium acetate buffer, and clearing buffer 1×PBS. The flow rate ratio (FRR) was 3:1 and the fastest total flow rate (TFR) was 18 ml/min. The lipid mixture was chosen for its ability to produce high quality particles, as well as its high rate of fouling. The 1×PBS entered at the clearing inlet. Two formulation runs of switching and no delay switching were conducted, with a clearing cycle of 100% Ethanol, 1×PBS, and water through all inlets between each run. For the no switching experiment, a 1 ml sample was collected per minute for a total of 8 minutes. For the switching experiment, separate samples were collected from the left and right sides sequentially for a total of 8 samples. An Ignite control sample was also formulated at a 12 ml/minute TFR, 3:1 FRR. An encapsulation assay and sizing were done for all samples.

Pressure transducers (Reotemp™) built into the cartridge 30 gathered data during the experiment. Samples were diluted 4× in 1×PBS.

No flow switching arm: The program was set to “no flow switching” on the instrument. One side of the microfluidic mixing platform cartridge 30 was open to organic and aqueous, and output led to the sample port, while the other side was only open to the clearing input (1×PBS) and outputs to the waste port.

Flow switching arm: The instrument coding was set for the microfluidic mixing platform cartridge 30 to have a zero-second delay post flow switching and harvest, and a 45-second interval between switch valve alteration. Pressure data was recorded throughout. This paradigm was run for the same amount of time that it took for a non-switching paradigm to reach 100 psi (tested under the same conditions otherwise). One large sample was collected for the entire run. Small samples (less than 1.5 mL) were taken from each of the right and left flow switching sides while mixing was occurring on that respective side.

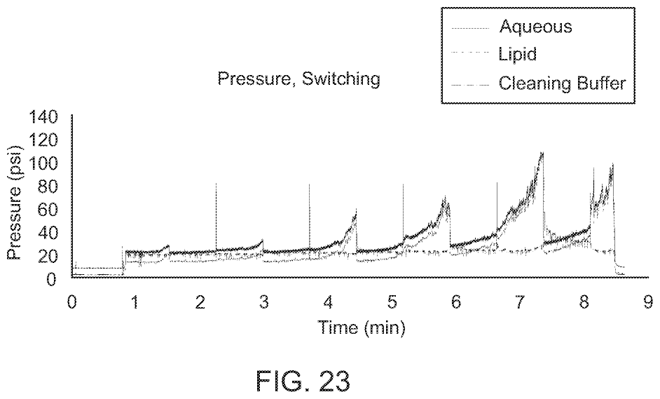

Results of the pressure testing and comparison between non-switching and switching are shown in FIGS. 22 and 23. The graphed data shows pressure building over time within the mixing platform. The high peak line extending to over 150 seconds corresponds to the un-switched mixing pressure of a C12-200 formulation. The graph in FIG. 23 shows the data achieved when switch mixing according to the invention was used.

Averaged pressures demonstrate that, with switching, pressure is maintained at a low baseline, while without switching, pressure continually increases until reaching a plateau, then suddenly drops when pumps are switched off at the end of the experiment run. The experiment was halted when the pressure reached 100 Psi (˜9 times the starting pressure). For the switching pressure graph, the “steps” are the pressures of either side of the chip mixing and the small spikes are caused by the valves opening and closing.

A portion of the total collected samples were aliquoted into an Amicon™ centrifuge tube and spun down at 2500 g for 30 minutes, and particles were assessed for size and encapsulation efficiency. The formulation nanoparticles were sized on the Zetasizer® DLS reader by diluting them until attenuation was at 8. Encapsulation efficiency was assessed by measuring the concentration ratio of encapsulated to total pDNA using a Quant-iT™ PicoGreen™ dsDNA assay and Biotek™ plate reader. The experiment was repeated for a total of two runs.

Size and encapsulation assays were run on the samples as described above. There was no measurable difference between particles formulated at low pressures with and without flow switching (Table 1). Yield was 98% in both cases. However, particles formulated at pressures above 90 psi due to fouling had poor encapsulation, high PDI and large size as seen in FIG. 24. This proves that the switch valve cartridge resulted in high-quality LNP while running longer to create more product than a traditional one-path microfluidic mixing cartridge, even with the high fouling C12-200 lipid and plasmid formulation.

TABLE 1
C12-200 average pDNA particle quality
before fouling (post-Amicon filter):

| Sample Name | Size | PDI | EE % |
|---|---|---|---|
| Standard Nanoassemblr ™ (single mixing | 101.2 | 0.158 | 82.2 |
| path) | | | |
| No flow switching 1^{st} run (samples 1-8) | 103.4 | 0.127 | 82.1 |
| Flow switching 1^{st} run (samples 1-8) | 83.4 | 0.103 | 76.2 |
| No flow switching 2^{nd} run (samples 1-3) | 109.1 | 0.132 | 83.4 |
| Flow switching 2^{nd} run (samples 1-8) | 85.1 | 0.104 | 80.2 |

### Example 4

Clearing Comparison

The microfluidic mixing platform was an Ignite™ NanoAssemblr® mixer. PendoTECH™ luer connection sensors (PREPS-N-000 model) were mounted to the ports on the Ignite™ cartridge block and connected to the syringes. These pressure transducers provided real-time feedback on the pressure increase inside the cartridge. FIG. 7 and FIG. 8 illustrates the fluid path of the experimental setup.

Lipid mixes were prepared by pipetting lipid stocks and ethanol into a 45 mL Falcon tube and vortex mixing, then filtering into a 15 mL Falcon tube either for immediate use, or if not being used right away, stored at −80 degrees C.

TABLE 2
Lipid Mixes

| | Per Trial | | Total Testing | | Stock | |
|---|---|---|---|---|---|---|
| Reagent | Volume | | Volume | | Concentration | |
| C12-200 | 21.095 | mL | 21.095 | mL | 80 | mg/mL |
| DOPE or POP | 14.532 | mL | 14.532 | mL | 20 | mg/mL |
| Cholesterol | 23.260 | mL | 23.260 | mL | 20 | mg/mL |
| PEG-DMG (2000) | 5.888 | mL | 5.888 | mL | 20 | mg/mL |
| Total | 250.000 | mL | 250.000 | mL | 20 | mg/mL |

The pDNA solution was added to the aqueous mixture, gently vortexed for 5 to 10 seconds, and the concentration of DNA was measured and recorded using a NanoDrop™ 2000/2000c Spectrophotometer (ThermoFisher Scientific). The same buffer/NaCaI mix with pDNA was used as a blank. Clearing solution was prepared using dd H₂O PBS and 1M Sodium Acetate, and diluted appropriately with ddH₂O.

The Ignite™ NanoAssemblr® microfluidic mixer was set to: 5 mL total volume, 3:1 FRR, TFR of 12 mL/min, loaded using 5 or 3 mL Becton Dickinson syringes, 1 mL start waste and 1 mL end waste. A two-inlet NxGen™ cartridge was inserted into the NanoAssemblr®. A 10 mL syringe aqueous phase was inserted into each of the first and second ports on the cartridge. Cleaning buffer was provided from a 5 or 10 mL syringe through a third port on the cartridge.

TABLE 3
The tested clearing buffers were:

| Formulation | Flow rate | Clearing Buffer |
|---|---|---|
| Control with | 12 mL/min | Ethanol (Substitute Solvent |
| MilliQ water | | for MilliQ Water) |
| C12-200 | 12 mL/min | PBS |
| C12-200 | 12 mL/min | Sodium acetate buffer |
| C12-200 | 12 mL/min | Water |
| C12-200 | 12 mL/min | Ethanol |

A control using the solvent of the clearing buffer was run through the experimental setup to ensure that the PendoTECH™ sensors were working and providing readable, consistent data. Solvent nominal (baseline) pressure varied by 1-3 PSI.

The PendoTECH™ pressure transducer sensor was started and the formulation was run. One-mL samples were collected at 10, 20, and 30 seconds. The PendoTECH™ sensor was stopped and the data file saved. After three runs, samples of 0.16 mL were tested on the Malvern ZS Zetasizer™. The variation in flow rates will help determine if the clearing method is shear or time dependent. Results are shown in FIG. ????

B. Repeat of Experiment Using More Commonly Used Formulation Materials

The formulation parameters below are based on repeatability and fouling testing previously conducted. A formulation shown to foul consistently was: C12-200 (47.5%), DOPE (12.5%), Cholesterol (38.5%), PEG (1.5%), N/P (3), 12.5 mM.

Sizing data was collected during different points in the formulation. Once the formulation started (meaning the reagents reached the mixer), the formulation was collected into 8 different samples separated by 20-second increments. FIG. 24 shows the size (vertical bars) and PDI (dots) of the collected samples over the run when the switch mixing of the invention was not used.

There was a large decrease in the size and a small decrease in the PDI over the length of the formulation. This indicates that the fouling was probably causing geometry changes in the NxGen™ 160 cartridge which was resulting in a change in the formulation parameters and results in differently formulated particle size and PDI. The first two data points are directly comparable to the control formulation collected in short 15-30 second runs. The samples were diluted 10× in PBS directly after the run. LNP size data was taken as duplicate data using the Malvern Zetasizer™ DLS.

During the first “no switching” run, pressures from the formulation lines steadily increased from 20 psi to 100 psi due to fouling. After 5 minutes, pressure plateaued at ˜110 psi. Cleaning pressure remained constant at 20 psi. After the first clearing run, all pressures again decreased to 20 psi. However, fouling occurred more quickly than the first run, with fluid pressures increasing to 110 psi after 3.5 minutes.

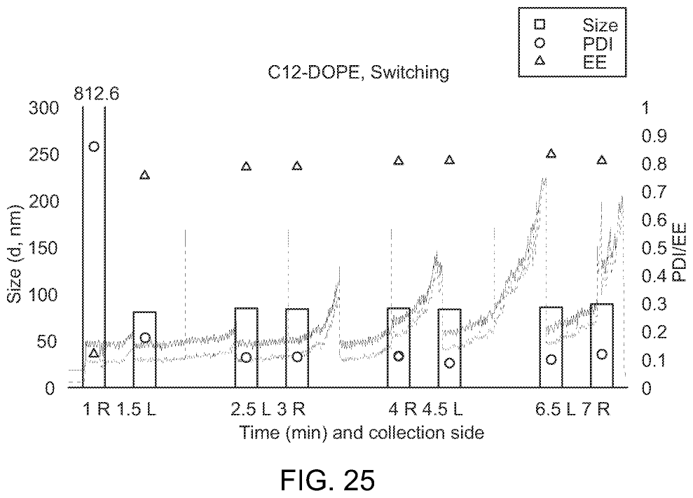

FIG. 25 shows the results when the switch mixing of the invention was used. To better illustrate the relationship between the size/PDI and the pressure increase/fouling, FIG. 25 shows an overlap of the two data sets, with the pressure profile overlaid on the sizing data. Formulation line pressure increased more gradually than with no switching, reaching a maximum of 50 psi after 8 minutes. After clearing, the second run also fouled more quickly than the first run, reaching 50 psi after 4 minutes and increasing to a maximum 110 psi after 7 minutes.

General Observations

The microfluidic mixing chip was disassembled and imaged between each experiment; in both the switching and non switching experiment fouling was visible inside of the mixer after a full clearing cycle, indicating that the clearing protocol was insufficient to completely clear fouling.

Particle quality for non-switching samples directly correlated with fouling observations. After 8 minutes for run 1 and after 4 minutes for run 2, particle size and PDI increased (>150 nm and >0.2) and encapsulation efficiency decreased dramatically (<15%) both pre and post Amicon filtration. For samples formulated before fouling occurred, an average of 80 nm pre-Amicon filtration and 100 nm post-Amicon filtration was measured, EE remained at approximately 80% for pre and post Amicon filtration samples. These results were consistent with Ignite controls.

Samples formulated with switching had overall good quality characteristics, apart from the first sample collected from each run. This was likely due to a priming error that resulted in air introduced to the fluid pumps, disrupting LNP formation. Otherwise, particle size was smaller than switching and ignite, with averages of 66 nm pre-Amicon filtration and 84 nm post Amicon filtration. PDI was an average of 0.1 for post-Amicon filtration samples and 0.2 for pre-Amicon filtration, comparable to Ignite controls. Encapsulation efficiency with switching was comparable to non switching and control, with an 83% average pre-Amicon filtration and 79% post-Amicon filtration.

FIG. 20 is a graphical illustration of Size, PDI, and encapsulation data for a C12-200:DOPE lipid formulation overlaid with line graph of pressure throughout the process.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A microfluidic mixing platform comprising:
a. at least a first input port and a second input port;
b. at least a first output port;
c. a flow path interconnecting the first input port, the second input port, and the first output port;
d. at least a first switch valve downstream of the first input port and upstream of the first output port, and at least a second switch valve downstream of the second input port and upstream of the first output port; and
e. at least a first mixing feature downstream of the first and second switch valves and upstream of the first output port;
wherein the first switch valve is switchable between at least a first state and a second state, wherein in the first state the first switch valve allows the first input port to be fluidly connected via the flow path to the first mixing feature, and wherein in the second state the first switch valve prevents the first input port from being fluidly connected to the first mixing feature, and
wherein the second switch valve is switchable between at least a first state and a second state, wherein in the first state the second switch valve allows the second input port to be fluidly connected via the flow path to the first mixing feature, and wherein in the second state the second switch valve prevents the second input port from being fluidly connected to the first mixing feature.

2. The microfluidic mixing platform of claim 1, further comprising one or more controllers configured to control the states of the first and second switch valves such that:
when the first switch valve is in the first state, the controller controls the second switch valve to be in the second state; and
when the first switch valve is in the second state, the controller controls the second switch valve to be in the first state.

3. The microfluidic mixing platform of claim 2, wherein the one or more controllers comprise a dedicated controller for each of the first and second switch valves.

4. The microfluidic mixing platform of claim 3, further wherein the dedicated switch controllers are programmable separately or as a group.

5. The microfluidic mixing platform of claim 1, further comprising:
a third switch valve downstream of the first mixing feature and upstream of the first output port,
wherein the third switch valve is switchable between at least a first state and a second state, wherein in the first state the third switch valve allows the first mixing feature to be fluidly connected via the flow path to the first output port, and wherein in the second state the third switch valve prevents the first mixing feature from being fluidly connected to the first output port.

6. The microfluidic mixing platform of claim 1, further comprising a waste output port downstream of the first mixing feature.

7. The microfluidic mixing platform of claim 6, further comprising:
a third switch valve downstream of the first mixing feature and upstream of the waste output port,
wherein the third switch valve is switchable between at least a first state and a second state, wherein in the first state the third switch valve allows the first mixing feature to be fluidly connected via the flow path to the waste output port, and wherein in the second state the third switch valve prevents the first mixing feature from being fluidly connected to the waste output port.

8. The microfluidic mixing platform of claim 1, further comprising a third input port interconnected to the first output port by the flow path.

9. The microfluidic mixing platform of claim 8, wherein the third input port is upstream of the first mixing feature.

10. The microfluidic mixing platform of claim 9, further comprising:
a third switch valve downstream of the third input port and upstream of the first output port,
wherein the third switch valve is switchable between at least a first state and a second state, wherein in the first state the third switch valve allows the third input port to be fluidly connected via the flow path to the first mixing feature, and wherein in the second state the third switch valve prevents the third input port from being fluidly connected to the first mixing feature.

11. The microfluidic mixing platform of claim 10, further comprising one or more controllers configured to control the states of the first and third switch valves such that:
when the first switch valve is in the first state, the controller controls the third switch valve to be in the first state; and
when the first switch valve is in the second state, the controller controls the third switch valve to be in the second state.

12. The microfluidic mixing platform of claim 8, wherein the first and third input ports are for the introduction of materials, and wherein the second input port is for the introduction of clearing buffer.

13. The microfluidic mixing platform of claim 8, wherein the first and second input ports are for the introduction of materials, and wherein the third input port is for the introduction of clearing buffer.

14. The microfluidic mixing platform of claim 1, wherein the output port is for the exit of materials having been mixed in the first mixing feature.

15. The microfluidic mixing platform of claim 1, wherein at least one of the first and second switch valves comprises a compression/diaphragm valve.

16. The microfluidic mixing platform of claim 1, wherein at least one of the first and second switch valves comprises a valve selected from a group consisting of: a socket valve; a rocker valve; a flipper valve; a plunger valve; a capillary valve; and a ball valve.

17. The microfluidic mixing platform of claim 1, wherein at least one of the first and second switch valves is switchable between the first state and the second state in response to volumetric pressure.

18. The microfluidic mixing platform of claim 1, wherein at least one of the first and second switch valves is switchable between the first state and the second state in response to pneumatic pressure.

19. The microfluidic mixing platform of claim 1, wherein at least one of the first and second switch valves is switchable between the first state and the second state by a solenoid.

20. The microfluidic mixing platform of claim 1, further comprising:
a. a third switch valve downstream of the first input port and upstream of the output port;
b. a fourth switch valve downstream of the second input port and upstream of the output port; and
c. a second mixing feature downstream of the third and fourth switch valves and upstream of the output port,
wherein the third switch valve is switchable between at least a first state and a second state, wherein in the first state the third switch valve allows the first input port to be fluidly connected via the flow path to the second mixing feature, and wherein in the second state the third switch valve prevents the first input port from being fluidly connected to the second mixing feature, and
wherein the fourth switch valve is switchable between at least a first state and a second state, wherein in the first state the fourth switch valve allows the second input port to be fluidly connected via the flow path to the second mixing feature, and wherein in the second state the fourth switch valve prevents the second input port from being fluidly connected to the second mixing feature.

21. The microfluidic mixing platform of claim 19, further comprising one or more controllers configured to control the states of the first, second, third, and fourth switch valves such that:
when the first switch valve is in the first state, the controller controls the second and third switch valves to be in the second state, and controls the fourth switch valve to be in the first state; and
when the first switch valve is in the second state, the controller controls the second and third switch valves to be in the first state, and controls the fourth switch valve to be in the second state.

22. The microfluidic mixing platform of claim 1, wherein the first mixing feature comprises one or both of a Dean's Vortex mixer and a herringbone mixer.

23. The microfluidic mixing platform of claim 1, further comprising one or more wireless communication components.

24. The microfluidic mixing platform of claim 23, wherein the one or more wireless communication components comprise one or more radiofrequency identification components.

25. A method of using a microfluidic mixing platform, the microfluidic mixing platform comprising:
a. at least a first input port and a second input port;
b. at least a first output port;
c. a flow path interconnecting the first input port, the second input port, and the first output port;
d. at least a first switch valve downstream of the first input port and upstream of the first output port, and at least a second switch valve downstream of the second input port and upstream of the first output port; and
e. at least a first mixing feature downstream of the first and second switch valves and upstream of the first output port,
wherein the method comprises:
controlling the first switch valve to allow the first input port to be fluidly connected via the flow path to the first mixing feature, and controlling the second switch valve to prevent the second input port from being fluidly connected to the first mixing feature;
thereafter, flowing a material from the first input port to the first mixing feature, via the flow path;
thereafter, controlling the first switch valve to prevent the first input port from being fluidly connected to the first mixing feature, and controlling the second switch valve to allow the second input port to be being fluidly connected via the flow path to the first mixing feature; and
thereafter, flowing a clearing buffer from the second input port to the first mixing feature, via the flow path.
